(19) United States
(12) Patent Application Publication
(10) Pub. No.: US 2024/0283186 A1
(43) Pub. Date: Aug. 22, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Takashi NATSUME, Mie (JP)

(21) Appl. No.: 18/567,180

(22) PCT Filed: Mar. 31, 2022
(86) PCT No.: PCT/JP2022/016458

§ 371 Date: Dec. 5, 2023

(30) Foreign Application Priority Data
Jun. 23, 2021 (JP) 2021-103935

(51) Int. Cl. H01R 13/424; H01R 13/504

(52) U.S. Cl. CPC H01R 13/424; H01R 13/504

(57) ABSTRACT

Peeling on a joint surface between a housing and a molded portion can be suppressed. A connector (10) is provided with a terminal fitting (30), a housing (20) including a holding portion (21) for holding the terminal fitting (30) and a receptacle (22) projecting from the holding portion (21), and a molded portion (40) for surrounding the housing (20). In the connector (10), a recess (50) is provided in a joint surface (20A) of the housing (20) with the molded portion (40).

### TECHNICAL FIELD

The present disclosure relates to a connector.

### BACKGROUND

Conventionally, a structure for protecting an electronic component such as a semiconductor device on a circuit board from dust and moisture has been used in an electronic device such as an ECU (Electronic Control Unit) or sensor module. For example, it is known to accommodate an electronic device in a case. In such a configuration, an adhesive is disposed on a joint part between cases or a space in a case is sealed with a potting resin. However, in the configuration using the case in this way, the size of an entire product increases and assembly process steps increase to increase cost.

Accordingly, it is thought to use a molded member (epoxy-based resin or the like) instead of the case. For example, a module device of Patent Document 1 is provided with a metal base, an electronic circuit board and a connector. The electrical circuit board is mounted on the metal base. The connector includes a terminal. One end of the terminal is connected to the electrical board. The metal base and the electronic circuit board are sealed with a sealing resin. The inside of the connector on the electronic circuit board side and the inside of a connector joint portion in the metal base are potted with a resin.

An in-vehicle electronic module of Patent Document 2 is provided with a circuit board and a connector. The connector includes a metal terminal. The metal terminal is connected to a connection terminal of the circuit board. In the circuit board, a part except a connected part to the connector is primarily molded with a resin. In the connection terminal, a part exposed between a package portion (molded member formed by primary molding) and a connector housing is secondarily molded with a resin.

### PRIOR ART DOCUMENT

### Patent Document

Patent Document 1: JP 2008-186955 A
Patent Document 2: JP 2013-004939 A

### SUMMARY OF THE INVENTION

### Problems to be Solved

However, in the configurations of Patent Documents 1 and 2, a problem that the molded member is peeled possibly occurs due to cooling after molding or cooling caused by a use environment. For example, since the connector housing and the molded member have different linear expansion coefficients, there is a thermal shrinkage difference between the connector housing and the molded member. Due to peeling caused by the thermal shrinkage difference between the connector housing and the molded member in this way, problems such as a reduction in waterproofness occur.

The present disclosure was completed on the basis of the above situation and aims to suppress peeling on a joint surface between a housing and a molded portion.

### Means to Solve the Problem

The present disclosure is directed to a connector with a terminal fitting, a housing including a holding portion for holding the terminal fitting and a receptacle projecting from the holding portion, and a molded portion for surrounding the housing, a recess being provided in a joint surface of the housing with the molded portion.

### Effect of the Invention

According to the present disclosure, it is possible to suppress peeling on a joint surface between a housing and a molded portion.

### BRIEF DESCRIPTION OF THE DRAWINGS

FIG. 1 is a perspective view of a connector of a first embodiment.

FIG. 2 is a perspective view of a housing assembled with terminal fittings when viewed from front.

FIG. 3 is a plan view of the housing assembled with the terminal fittings when viewed from behind.

FIG. 4 is a front view of the housing assembled with the terminal fittings.

FIG. 5 is a back view of the housing mounted with the terminal fittings.

FIG. 6 is a plan view in section of the connector when viewed from above.

FIG. 7 is a side view in section of the connector when viewed from left.

FIG. 8 is a back view of a housing assembled with terminal fittings in a second embodiment.

FIG. 9 is a plan view in section of a connector of the second embodiment when viewed from above.

FIG. 10 is a side view in section of the connector of the second embodiment when viewed from left.

FIG. 11 is a diagram schematically showing a part of a back surface in a housing assembled with a terminal fitting in another embodiment.

### DETAILED DESCRIPTION TO EXECUTE THE INVENTION

### Description of Embodiments of Present Disclosure

First, embodiments of the present disclosure are listed and described.
(1) The connector of the present disclosure is provided with a terminal fitting, a housing including a holding portion for holding the terminal fitting and a receptacle projecting from the holding portion, and a molded portion for surrounding the housing, a recess being provided in a joint surface of the housing with the molded portion.

According to the configuration of the present disclosure, a shrinkage amount in directions along the joint surface with the molded portion is reduced and stress in the directions along the joint surface is reduced during the thermal deformation by providing the recess in the joint surface of the housing with the molded portion. Thus, peeling on the joint surface between the housing and the molded portion can be suppressed.
(2) Preferably, the terminal fitting is passed through the holding portion and projects toward a back surface of the holding portion and the receptacle, and the recess is provided in the back surface of the holding portion.

According to this configuration, the terminal fitting is passed through the back surface of the housing and the peeling of the back surface from the molded portion is suppressed by the recess. Thus, the waterproofness of the back surface of the housing is maintained and the occurrence of a short circuit and the like between the terminals due to water intrusion or the like can be suppressed.
(3) Preferably, the recess is provided around the terminal fitting in the back surface.

According to this configuration, the peeling of the molded portion around the terminal fitting can be suppressed in the back surface of the holding portion. Thus, waterproofness around the terminal fitting in the back surface of the holding portion can be further enhanced.
(4) Preferably, the recess is provided to surround a formation region of a plurality of the terminal fittings in the back surface over an entire periphery.

According to this configuration, the peeling of the molded portion around the terminal fittings can be further suppressed in the back surface of the holding portion.
(5) Preferably, a pair of the recesses are provided, and the pair of recesses are located across the terminal fitting in the back surface.

According to this configuration, there are positions, where stress in the directions along the joint surface is reduced, across the terminal fitting in the back surface of the holding portion, and the peeling of the molded portion around the terminal fitting is easily suppressed.
(6) Preferably, three or more recesses are provided, and the three or more recesses are scattered to surround the terminal fitting in the back surface.

According to this configuration, there are positions, where stress in the directions along the joint surface is reduced, across the terminal fitting in the back surface of the holding portion, and the peeling of the molded portion around the terminal fitting is easily suppressed.

### Details of Embodiments of Present Disclosure

### First Embodiment

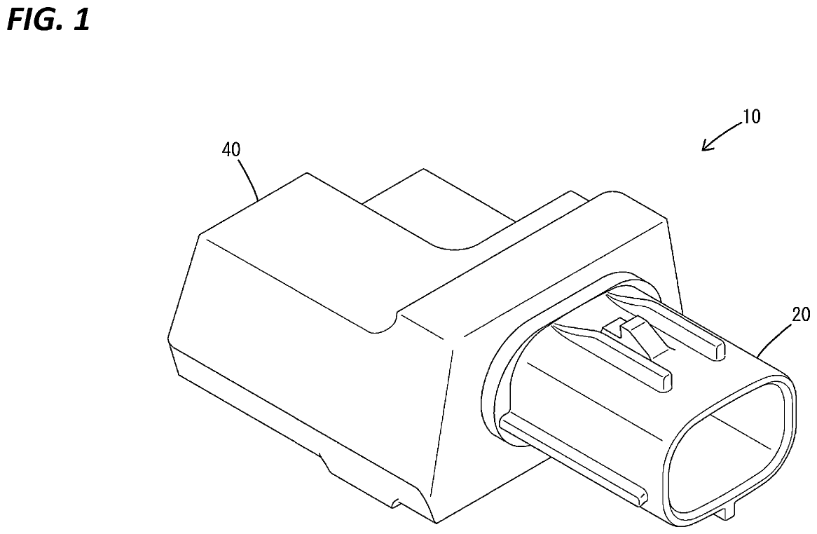

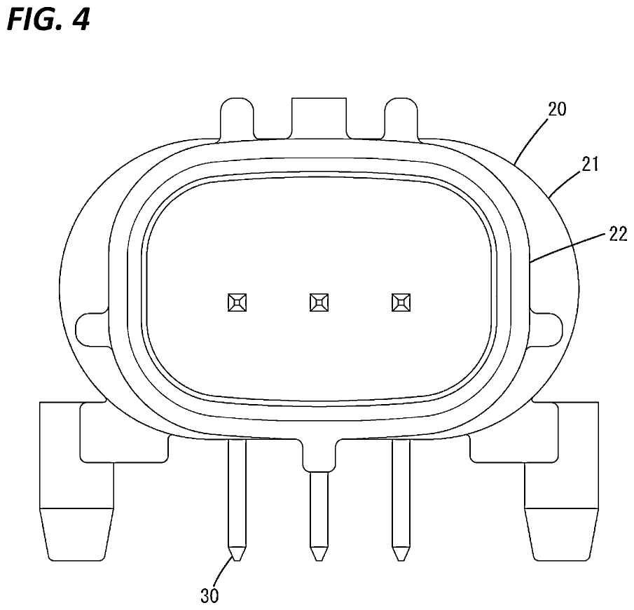

A first specific embodiment of a connector of the present disclosure is described with reference to FIGS. 1 to 7. In the first embodiment, upper and lower sides shown in FIGS. 1 to 5 and 7 are directly defined as upper and lower sides concerning a vertical direction. Right and left sides shown in FIGS. 1 to 3, 6 and 7 are respectively defined as front and rear sides concerning a front-rear direction. Left and right sides shown in FIG. 4 are directly defined as left and right sides concerning a lateral direction.

### (Configuration of Connector)

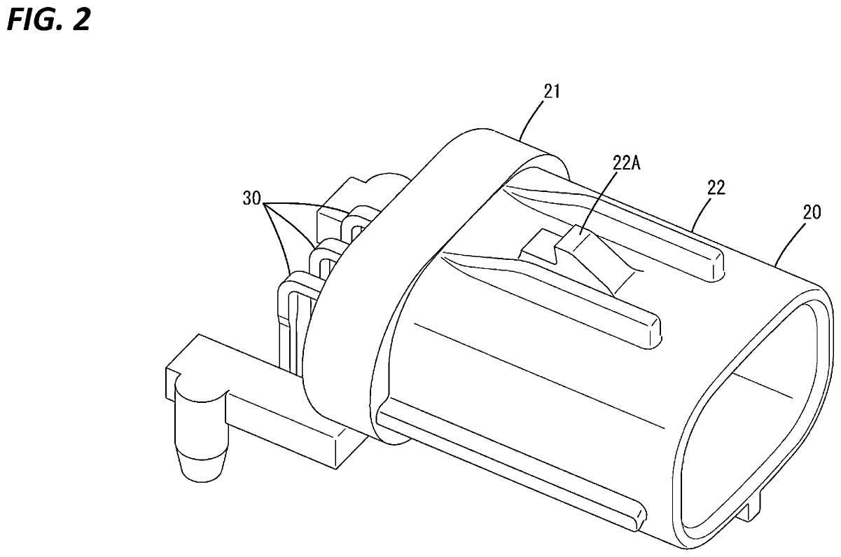

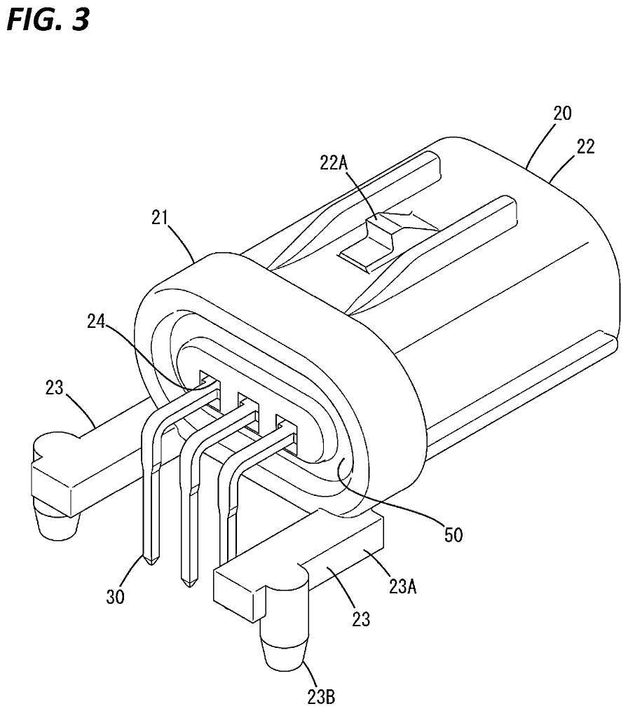

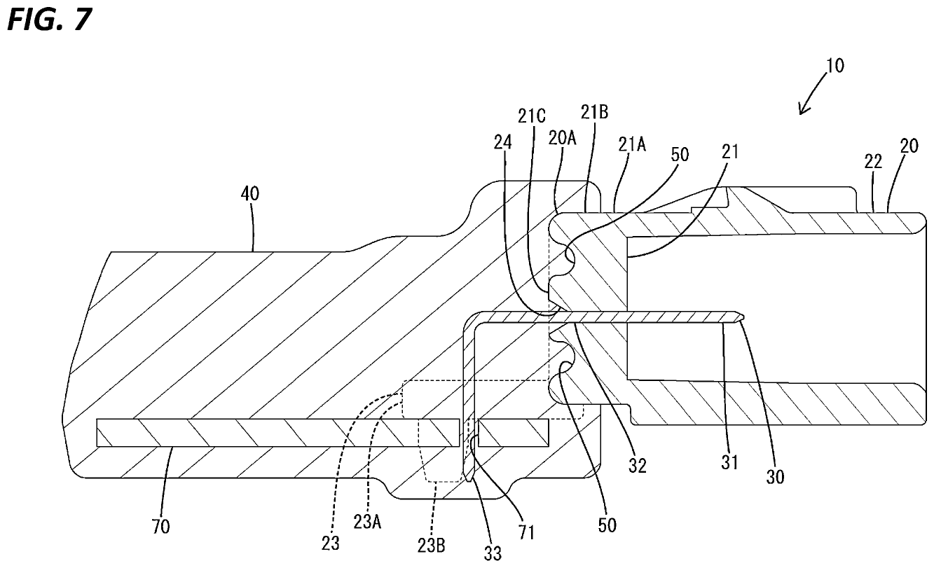

A connector 10 of the first embodiment is, as shown in FIG. 1, provided with a housing 20, terminal fittings 30 (see FIGS. 2 and 3) and a molded portion 40. The housing 20 is connectable to an unillustrated mating housing. The connector 10 is mounted on a circuit board 70 as shown in FIG. 7.

The housing 20 is, for example, made of synthetic resin. The housing 20 is, for example, made of a material such as polybutylene terephthalate (linear expansion coefficient: about 1.1×10⁻⁴/C°) or polyamide (linear expansion coefficient: about 1.0×10⁻⁴/C°). As shown in FIGS. 2 and 3, the housing 20 is provided with a holding portion 21, a receptacle 22 and a pair of extending portions 23. As shown in FIGS. 2 and 3, the receptacle 22 projects forward from the holding portion 21. The receptacle 22 is in the form of a rectangular tube with rounded corners. The receptacle 22 is provided with a lock projection 22A. The lock projection 22A enters and locks a lock receiving portion (not shown) of the mating housing with the housing 20 and the mating housing connected.

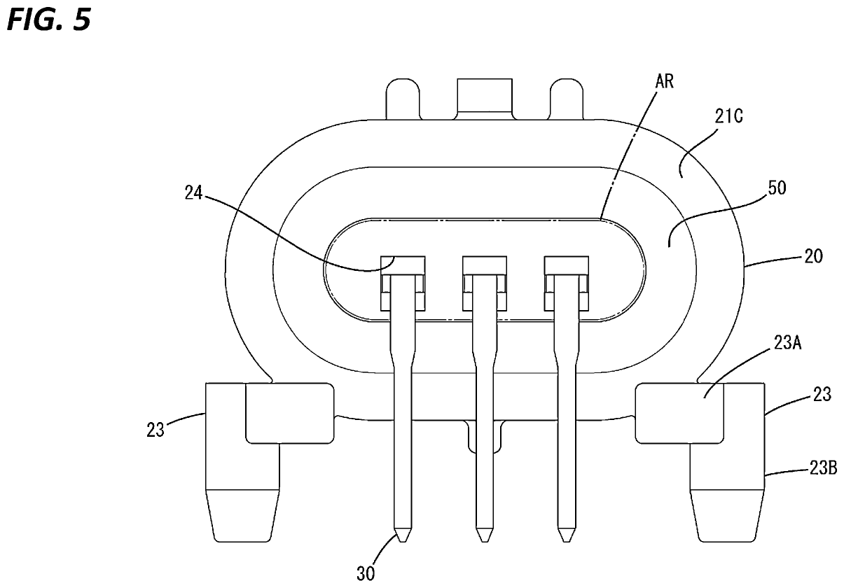

The holding portion 21 holds the terminal fittings 30. The holding portion 21 is a wall portion orthogonal to the front-rear direction (connection direction of the housing 20 and the mating housing). The holding portion 21 has an oval shape long in the lateral direction when viewed from the front-rear direction. As shown in FIGS. 2 and 4, edges on both left and right sides of the holding portion 21 arcuately project further laterally outward than the receptacle 22. As shown in FIGS. 3 and 5, the holding portion 21 is provided with a plurality of holes 24 (e.g. three holes 24) penetrating in the front-rear direction. The plurality of holes 24 are provided in parallel in the lateral direction in a central region of the holding portion 21 when viewed from the front-rear direction. The terminal fitting 30 is press-fit and mounted into each hole 24.

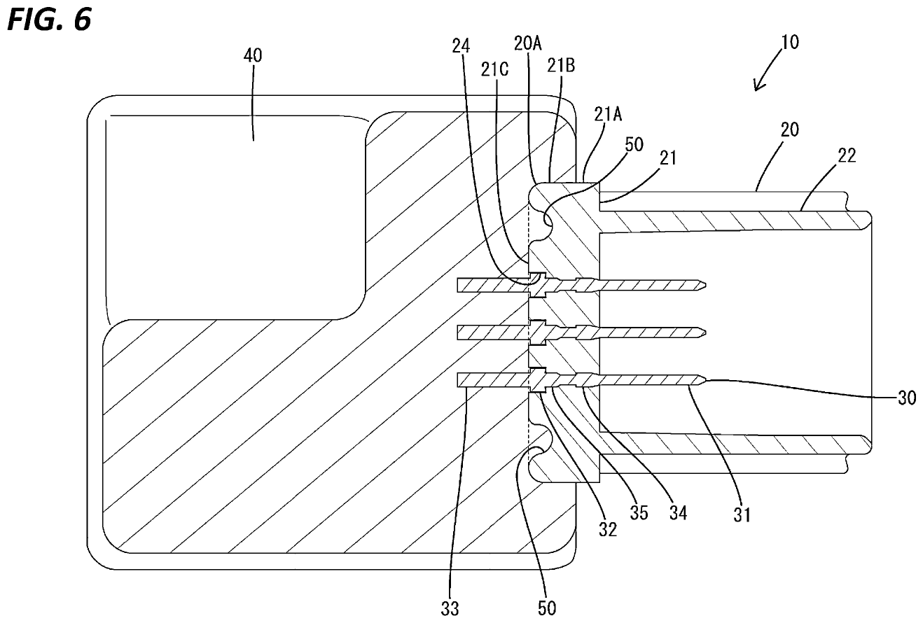

As shown in FIGS. 6 and 7, the outer peripheral surface of the holding portion 21 has an exposed portion 21A and a covering portion 21B. The exposed portion 21A constitutes a front end side of the outer peripheral surface of the holding portion 21. The exposed portion 21A is not surrounded by the molded portion 40 to be described later. As shown in FIG. 6, both left and right edges of the exposed portion 21A are formed to be stepped with respect to both left and right edges of the outer peripheral surface of the receptacle 22. When the molded portion 40 is molded, a mold used for molding can be brought into contact with and supports the exposed portion 21A. The outer edge of a back surface (rear surface) 21C of the holding portion 21 is smoothly connected to the covering portion 21B without being angular.

As shown in FIGS. 6 and 7, the covering portion 21B constitutes a rear end side part of the outer peripheral surface of the holding portion 21. The covering portion 21B is surrounded by the molded portion 40 to be described later.

As shown in FIGS. 3 and 5, the extending portions 23 respectively extend rearward from both left and right ends of the lower end of the holding portion 21. The extending portion 23 includes an extending piece 23A and a projecting portion 23B. The extending piece 23A has a rectangular parallelepiped shape and extends rearward from the holding portion 21. As shown in FIG. 7, the extending piece 23A is arranged on the upper surface of the circuit board 70. As shown in FIGS. 3 and 5, the projecting portion 23B projects downward at a position on a laterally outer edge of the extending piece 23 and slightly in front of a rear end. The projecting portion 23B has a cylindrical shape with a tapered tip. As shown in FIG. 7, the projecting portion 23B is inserted into a hole (not shown) of the circuit board 70. A pair of the extending portions 23 are disposed at positions across board connecting portions 33 of the terminal fittings 30 to be described later in the lateral direction.

The terminal fitting 30 is made of electrically conductive metal. As shown in FIGS. 6 and 7, the terminal fitting 30 is in the form of a pin having a rectangular cross-section. The terminal fitting 30 is passed through the holding portion 21 and projects toward the back surface 21C of the holding portion 21 and the receptacle 22. The terminal fitting 30 includes a mating connecting portion 31, an intermediate portion 32 and the board connecting portion 33. In the terminal fitting 30, the mating connecting portion 31, the intermediate portion 32 and the board connecting portion 33 are coupled side by side in this order from front. The mating connecting portion 31 is in the form of an elongated tab extending long from the intermediate portion 32. The mating connecting portion 31 is electrically connected to a mating terminal fitting (not shown) held in the mating housing at the time of connecting the housing 20 and the mating housing (not shown). The mating connecting portion 31 is provided with claw-like locking pieces 34, 35 protruding toward both left and right sides at positions near a rear end (positions near the intermediate portion 32). The locking pieces 34, 35 bite into the inner surface of the hole 24 of the holding portion 21 for locking.

The intermediate portion 32 is connected to the rear end of the mating connecting portion 31. The intermediate portion 32 is in the form of a rectangular plate. The intermediate portion 32 has plate surfaces orthogonal to the vertical direction. The intermediate portion 32 is disposed on the inner surface of the hole 24 of the holding portion 21.

The board connecting portion 33 is connected to the rear end of the intermediate portion 32. The board connecting portion 33 is in the form of an elongated tab extending from the intermediate portion 32. The board connecting portion 33 is bent at a halfway position in an extending direction and L-shaped when viewed from the lateral direction. As shown in FIG. 7, the board connecting portion 33 is mounted through a hole 71 and electrically connected to an electrically conductive portion (not shown) of the circuit board 70 when the housing 20 is fixed to the circuit board 70. The hole 71 is a hole penetrating through the circuit board 70 in a plate thickness direction.

As shown in FIG. 7, the molded portion 40 is molded with a synthetic resin (epoxy-based resin or the like) and integrates the housing 20, the terminal fittings 30 and the circuit board 70. The molded portion 40 is, for example, made of a material having a smaller linear expansion coefficient than the housing 20 such as an epoxy resin (linear expansion coefficient: about 3.0×10⁻⁴/C°). The molded portion 40 surrounds the housing 20, the terminal fitting 30 and the circuit board 70. More specifically, the molded portion 40 surrounds a structure in which the housing 20 is mounted on the circuit board 70. The molded portion 40 surrounds only a rear end side (covering portion 21B) of the holding portion 21 without covering the outer peripheral surface of the receptacle 22. The molded portion 40 covers the covering portion 21B over an entire periphery except coupled parts to the extending portions 23. The outer peripheral surface of the receptacle 22 can be utilized as a part for realizing a function of the connector 10 (part where the mating housing is assembled or the like). The molded portion 40 entirely surrounds the terminal fittings 30 exposed from the housing 20 and the circuit board 70. The molded portion 40 entirely surrounds the extending portions 23 exposed from the circuit board 70.

### (Configuration of Recess)

As shown in FIGS. 6 and 7, a recess 50 is provided in a joint surface 20A of the housing 20 with the molded portion 40. The joint surface 20A includes the back surface 21C, the covering portion 21B and surfaces (outer surfaces) of the extending portions 23. Specifically, the recess 50 is provided around the terminal fittings 30 in the back surface 21C. The recess 50 is provided to surround a formation region AR (see FIG. 5) of the plurality of terminal fittings 30 in the back surface 21C over an entire periphery. The formation region AR is provided in a center of the back surface 21C. The formation region AR is a region including the holes 24 and expanding further outward than the holes 24.

As shown in FIGS. 6 and 7, the recess 50 is shaped along the outer shape of the holding portion 21 and has an oval ring shape long in the lateral direction. The recess 50 has a semicircular cross-sectional shape. An opening part (rear edge) of the recess 50 is curved without being angular. As shown in FIG. 7, the back surface 21C has a repeated convex and concave wavy shape in the vertical direction by the recess 50 and the holes 24 in a cross-section viewed from the lateral direction. The molded portion 40 enters the recess 50 and the holes 24.

For example, if the linear expansion coefficient of the housing 20 and that of the molded portion 40 are different, there is a thermal shrinkage difference between these. Peeling due to thermal shrinkage may occur between the housing 20 and the molded portion 40 due to cooling after molding or cooling caused by a use environment. Accordingly, the recess 50 is provided in the back surface 21C, out of the joint surface 20A of the housing 20 with the molded portion 40. By forming the recess 50 in the back surface 21C, a shrinkage amount of the housing 20 during thermal deformation can be reduced in the vertical direction and lateral direction along a plane region where the recess 50 is not formed and the formation region AR, out of the back surface 21C. Thus, stress generated in the housing 20 is reduced in directions along the plane region where the recess 50 is not formed and the formation region AR, out of the back surface 21C. Therefore, peeling on the joint surface 20A of the housing 20 with the molded portion 40 can be suppressed. A peeling suppressing effect is high in the covering portion 21B orthogonal to the directions, in which the stress of the housing 20 is reduced, out of the joint surface 20A.

Particularly, since the recess 50 is provided in the back surface 21C, the peeling of the back surface 21C from the molded portion 40 is suppressed. Thus, the waterproofness of the back surface 21C of the housing 20 is maintained and the occurrence of a short circuit and the like between the terminal fittings 30 due to water intrusion or the like can be suppressed. Further, since the recess 50 is provided to surround the formation region AR (see FIG. 5) over the entire periphery in the back surface 21C, waterproofness around the terminal fittings 30 on the back surface 21C can be further enhanced.

### Effects of Embodiment

As described above, according to the connector 10 of the present disclosure, the recess 50 is provided in the joint surface 20A of the housing 20 with the molded portion 40. In this way, the shrinkage amount in the directions along the joint surface 20A with the molded portion 40 is reduced and stress in the directions along the joint surface 20A is reduced during thermal deformation. Thus, the peeling on the joint surface 20A of the housing 20 with the molded portion 40 can be suppressed.

According to the connector 10 of the present disclosure, the terminal fittings 30 are passed through the holding portion 21 and project toward the back surface 21C of the holding portion 21 and the receptacle 22. The recess 50 is provided in the back surface 21C of the holding portion 21. In this way, the terminal fittings 30 are passed through the back surface 21C of the housing 20 and the peeling of the back surface 21C from the molded portion 40 is suppressed by the recess 50. Thus, the waterproofness of the back surface 21C of the housing 20 and is maintained and the occurrence of a short circuit and the like between the terminal fittings 30 due to water intrusion or the like can be suppressed.

According to the connector 10 of the present disclosure, the recess 50 is provided around the terminal fittings 30 in the back surface 21C. In this way, the peeling of the molded portion 40 around the terminal fittings 30 can be suppressed on the back surface 21C of the holding portion 21. Thus, waterproofness around the terminal fittings 30 on the back surface 21C of the holding portion 21 can be further enhanced.

According to the connector 10 of the present disclosure, the recess 50 is provided to surround the formation region AR of the plurality of terminal fittings 30 in the back surface 21C over the entire periphery. In this way, the peeling of the molded portion 40 around the terminal fittings 30 can be further suppressed on the back surface 21C of the holding portion 21.

### Second Embodiment

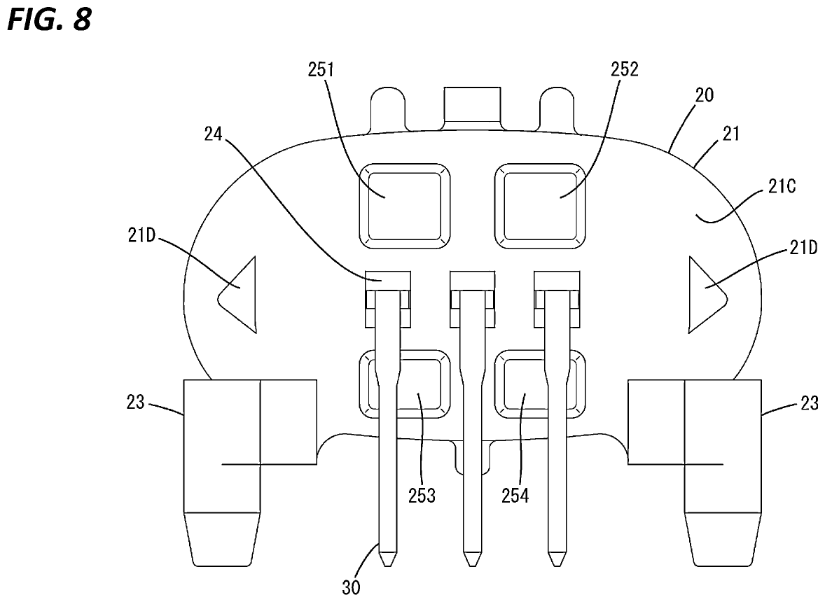

FIGS. 8 to 10 are figures showing a connector of a second embodiment. The second embodiment differs from the first embodiment in the configuration of recesses. The other configuration is the same as in the first embodiment and not described in detailed.

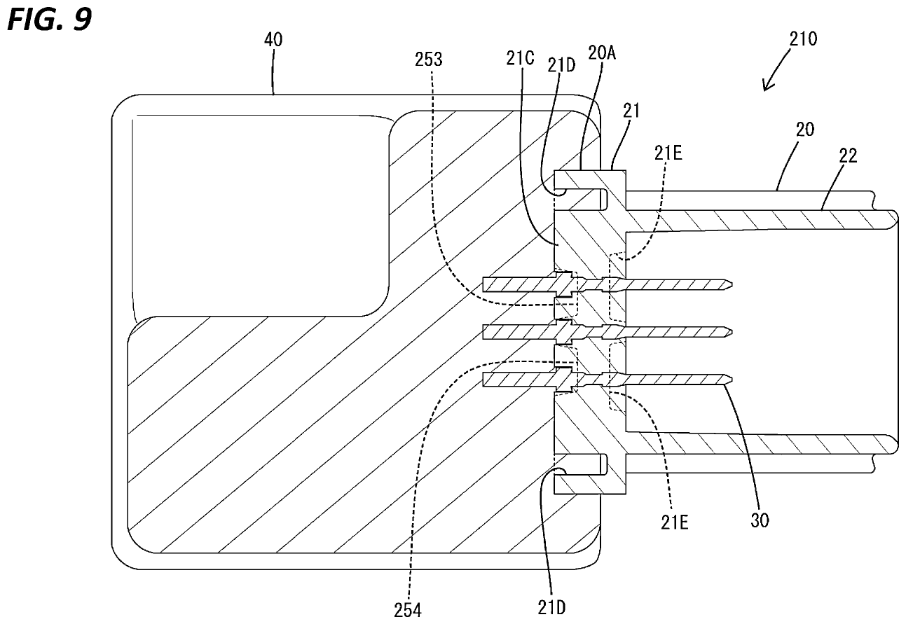

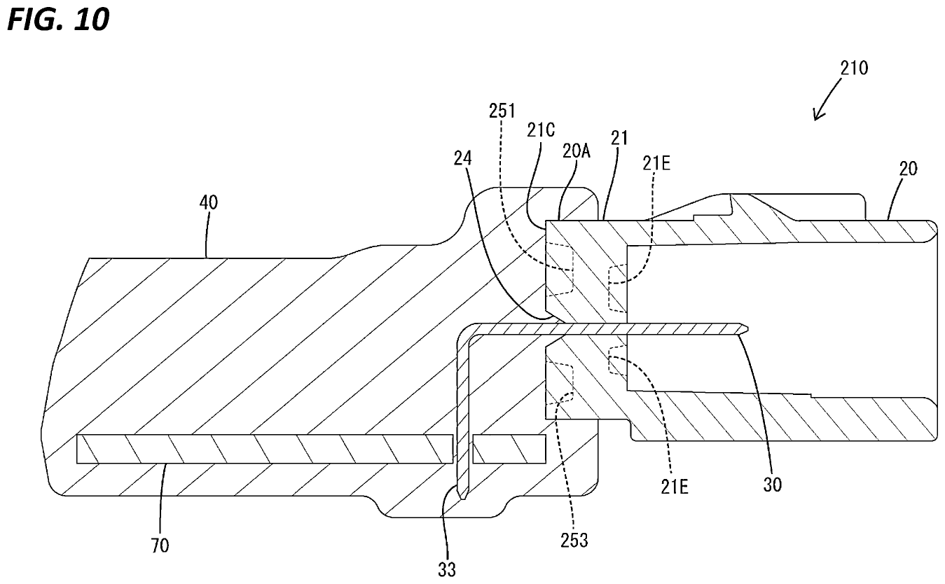

A connector 210 of the second specific embodiment of the connector of the present disclosure is described with reference to FIGS. 8 to 10. In the second embodiment, upper and lower sides shown in FIGS. 8 and 10 are directly defined as upper and lower sides concerning a vertical direction. Right and left sides shown in FIGS. 9 and 10 are respectively defined as front and rear sides concerning a front-rear direction. Right and left sides shown in FIG. 8 are directly defined as left and right sides concerning a lateral direction.

As shown in FIG. 8, four recesses 251, 252, 253 and 254 are provided in a joint surface 20A of a housing 20 with a molded portion 40. The recesses 251, 252, 253 and 254 are provided around terminal fittings 30 in a back surface 21C. The recess 251, 252, 253, 254 has a rectangular shape when viewed from behind. As shown in FIG. 10, the recess 251, 252, 253, 254 has a trapezoidal cross-section narrowed toward a front side when viewed from the lateral direction. A pair of the recesses 251, 253 are disposed side by side in the vertical direction at right side positions in the back surface 21C. The pair of recesses 251, 253 are positioned across the terminal fitting 30 on a right side. A pair of the recesses 252, 254 are disposed side by side in the vertical direction at left side positions in the back surface 21C. The pair of recesses 252, 254 are positioned across the terminal fitting 30 on a left side. The recesses 251, 252, 253 and 254 are scattered to surround the central terminal fitting 30 in the back surface 21C. The molded portion 40 enters the recesses 251, 252, 253 and 254.

By providing the recesses 251, 252, 253 and 254 in the joint surface 20A of the housing 20 with the molded portion 40, a shrinkage amount of the housing 20 in directions along the joint surface 20A can be reduced during thermal deformation. Thus, stress in the directions along the joint surface 20A in the housing 20 is reduced. Thus, peeling on the joint surface 20A between the housing 20 and the molded portion 40 can be suppressed.

Particularly, since the recesses 251, 252, 253 and 254 are provided in the back surface 21C of the holding portion 21, the peeling of the back surface 21C from the molded portion 40 is suppressed. Thus, the waterproofness of the back surface 21C of the housing 20 is maintained and the occurrence of a short circuit and the like between the terminal fittings 30 due to water intrusion or the like can be suppressed. Further, since the pair of recesses 251, 253 are located across the terminal fitting 30 on the right side, there are positions, where stress in the directions along the joint surface 20A is reduced, across the terminal fitting 30 on the right side. Similarly, since the pair of recesses 252, 254 are located across the terminal fitting 30 on the left side, there are positions, where stress in the directions along the joint surface 20A is reduced, across the terminal fitting 30 on the left side. In the above way, the peeling of the molded portion 40 around the terminal fittings 30 is easily suppressed.

As shown in FIGS. 8 and 9, first lightening portions 21D are respectively provided near both left and right edges of the back surface 21C of the holding portion 21. The first lightening portions 21D are at positions overlapping holes 24 in the lateral direction. The first lightening portion 21D has a triangular shape when viewed from behind.

As shown in FIGS. 9 and 10, four second lightening portions 21E recessed rearward are provided in the front surface of the holding portion 21. A pair of the second lightening portions 21E on an upper side are provided above three holes 24. A pair of the second lightening portions 21E on a lower side are provided below the three holes 24.

### Other Embodiments

The present invention is not limited to the above described and illustrated embodiments, but is represented by claims. The present invention is intended to include all changes in the scope of claims and in the meaning and scope of equivalents and also include the following embodiments.

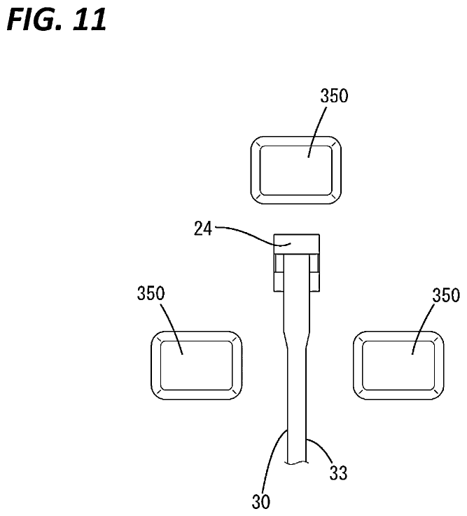

Unlike the above first and second embodiments, three or more recesses 350 may be provided in the back surface 21C in an arrangement shown in FIG. 11. FIG. 11 is a diagram showing a structure near the hole 24 in the back surface 21C of the holding portion 21 when viewed from behind. As shown in FIG. 11, the three recesses 350 may be scattered to surround the terminal fitting 30 in the back surface 21C.

Although the recesses 50, 251, 252, 253 and 254 are provided in the back surface 21C of the holding portion 21 in the above first and second embodiments, recesses may be provided at other positions in the joint surface 20A. For example, the recesses 50, 251, 252, 253 and 254 may be provided in the outer peripheral surface (covering portion 21B) of the holding portion 21 or in the extending portions 23.

Although the recess 50 is provided to surround the formation region AR of the plurality of terminal fittings 20 over the entire periphery in the back surface 21C in the first embodiment, a recess 50 may be provided in a part around the formation region AR.

Although the pair of recesses 251, 253 and the pair of recesses 252, 254 are respectively disposed across the terminal fittings 30 in the vertical direction in the second embodiment, recesses may be disposed across the terminal fittings 30 in another direction (lateral direction or the like).

List of Reference Numerals

| | |
|---|---|
| 10 | connector |
| 20 | housing |
| 20A | joint surface |
| 21 | holding portion |
| 21A | exposed portion |
| 21B | covering portion |
| 21C | back surface (rear surface) |
| 21D | first lightening portion |
| 21E | second lightening portion |
| 22 | receptacle |
| 22A | lock projection |
| 23 | extending portion |
| 23A | extending piece |
| 23B | projecting portion |
| 24 | hole |
| 30 | terminal fitting |
| 31 | mating connecting portion |
| 31C | back surface |
| 32 | intermediate portion |
| 33 | board connecting portion |
| 34, 35 | locking piece |
| 40 | molded portion |
| 50 | recess |
| 70 | circuit board |
| 71 | hole |
| 210 | connector |
| 251, 252, 253, 254 | recess |
| 350 | recess |
| AR | formation region |

1. A connector, comprising:
a terminal fitting;
a housing including a holding portion for holding the terminal fitting and a receptacle projecting from the holding portion; and
a molded portion for surrounding the housing,
a recess being provided in a joint surface of the housing with the molded portion.

2. The connector of claim 1, wherein:
the terminal fitting is passed through the holding portion and projects toward a back surface of the holding portion and the receptacle, and
the recess is provided in the back surface of the holding portion.

3. The connector of claim 2, wherein the recess is provided around the terminal fitting in the back surface.

4. The connector of claim 3, wherein the recess is provided to surround a formation region of a plurality of the terminal fittings in the back surface over an entire periphery.

5. The connector of claim 3, wherein:
a pair of the recesses are provided, and
the pair of recesses are located across the terminal fitting in the back surface.

6. The connector of claim 3, wherein:
three or more recesses are provided, and
the three or more recesses are scattered to surround the terminal fitting in the back surface.
